(19) United States
(12) Patent Application Publication
(10) Pub. No.: US 2025/0375670 A1
(43) Pub. Date: Dec. 11, 2025

(54) BASKETBALL WITH ETHYLENE VINYL ACETATE COVER PANELS AND MANUFACTURING METHOD THEREOF

(71) Applicant: YUAN CHI SPORTS ENTERPRISE CO., LTD., Taipei City (TW)

(72) Inventor: Shyh-Kuen LIN, Taipei City (TW)

(73) Assignee: YUAN CHI SPORTS ENTERPRISE CO., LTD., Taipei City (TW)

(21) Appl. No.: 18/735,362

(22) Filed: Jun. 6, 2024

(51) Int. Cl. A63B 41/08; A63B 45/00; C08J 9/00; C08J 9/10; C08K 3/22; C08K 3/26; C08K 5/09; C08K 13/02; C08L 23/08

(52) U.S. Cl. CPC A63B 41/08; A63B 45/00; C08J 9/0061; C08J 9/0095; C08J 9/103; C08K 13/02; C08L 23/0853; A63B 2209/00; A63B 2243/0037; C08J 2203/04; C08J 2323/08; C08J 2407/00; C08J 2423/06; C08J 2493/04; C08K 2003/2296; C08K 2003/265; C08K 5/09; C08K 2201/014; C08L 2203/12; C08L 2205/025; C08L 2205/035; C08L 2312/00

(57) ABSTRACT

Provided is a basketball with EVA cover panels, which comprises a basketball carcass, and at least two cover panels disposed on a surface of the basketball carcass; wherein the at least two cover panels are made by foaming a cover panel material, and the cover panel material comprises ethylene vinyl acetate, a foaming agent, a filler, polyethylene, natural rubber, a crosslinking agent, zinc oxide, stearic acid and an anti-wear agent. The basketball with EVA cover panels of the present invention can have good elasticity, good touch and non-slip at the same time.

### BACKGROUND OF THE INVENTION

### 1. Field of the Invention

The present invention relates to a basketball and a manufacturing method thereof, particularly to a basketball with ethylene vinyl acetate (EVA) cover panels and a manufacturing method thereof.

### 2. Description of the Prior Arts

Basketball sport is a globally popular sport and involves tremendous commercial activities and related entertainments. In order to make sure the participants of the basketball sport have good experience, not only the skills and performance of basketball players, but also the quality of a basketball used for the basketball sport play an important role.

In general, a basketball has a basketball carcass and several cover panels attached to a surface of the basketball carcass. The basketball carcass typically has an inflatable and spherical bladder, a yarn wrapped layer covering the surface of the bladder and formed by wrapping yarns on the surface of the bladder, and a middle layer formed on the surface of the yarn wrapped layer. The basketball carcass gives the basketball a basic and fixed structure and contributes to the main mass of the basketball.

As for the cover panels, many materials can be used for producing the cover panels, such as rubber, polyvinyl chloride (PVC), polyurethane (PU), or cowhide. Even so, as the desired properties, such as good elasticity and good wearing capacity, of the basketball basically depend on the properties of the cover panels, the material choices of the cover panels which provide desired properties are highly concerned.

PU is the most common material for producing cover panels of a basketball due to its good wearing capacity, which means that a basketball with PU cover panels has longer available time before its cover panels are worn out. However, the basketball with PU cover panels does not have adequate elasticity and soft touch but have hard and plastic touch, which may affect the performance of basketball players.

Instead, EVA is another material used for producing cover panels of a basketball, and by subjecting EVA to a foaming process, the cover panels made from a foamed EVA show better elasticity and touch than that made from PU. Nevertheless, the foamed EVA usually has too low density for processing on its surface, and the touch of the cover panels made from the foamed EVA is smooth, such that a basketball with the foamed EVA cover panels is prone to slippage.

Accordingly, there is still a need to research and develop a basketball, which has good elasticity, good touch and non-slip at the same time, thereby positively contributing to the basketball sport.

### SUMMARY OF THE INVENTION

In view of the problems in the prior art, the object of the present invention is to provide a basketball that can simultaneously have properties of good elasticity, good touch and non-slip.

To achieve the foresaid object, the present invention provides a basketball with EVA cover panels, which comprises: a basketball carcass, and at least two cover panels disposed on a surface of the basketball carcass; wherein the at least two cover panels are made by foaming a cover panel material, and the cover panel material comprises EVA, a foaming agent, a filler, polyethylene (PE), natural rubber (NR), a crosslinking agent, zinc oxide (ZnO), stearic acid and an anti-wear agent.

By adopting the specific composition of the cover panel material, the basketball with EVA cover panels of the present invention can have properties of good elasticity, good touch and non-slip at the same time, thereby providing a basketball with different materials of cover panels that benefits the participants of the basketball sport.

In some embodiments of the present invention, in the cover panel material, based on a weight of EVA as 100 parts by weight, a content of the foaming agent is from 8 parts by weight to 15 parts by weight, a content of the filler is from 60 parts by weight to 110 parts by weight, a content of PE is from parts by weight to 80 parts by weight, a content of NR is from 20 parts by weight to 40 parts by weight, a content of the crosslinking agent is from 2 parts by weight to 4 parts by weight, a content of ZnO is from 1 part by weight to 5 parts by weight, a content of stearic acid is from 1 part by weight to 5 parts by weight and a content of the anti-wear agent is from 2 parts by weight to 6 parts by weight.

In some embodiments of the present invention, in the cover panel material, based on a weight of EVA as 100 parts by weight, a content of the filler is from 90 parts by weight to 110 parts by weight.

In some embodiments of the present invention, a density of EVA in the cover panel material may be from 0.91 g/cm³ to 0.96 g/cm³, but it is not limited thereto. In some embodiments of the present invention, a melting point of EVA in the cover panel material may be from 60° C. to 105° C., but is not limited thereto. In some embodiments of the present invention, EVA in the cover panel material may be produced by degradable materials extracted from plants.

In some embodiments of the present invention, a density of PE in the cover panel material may be from 0.92 g/cm³ to 0.925 g/cm³, but it is not limited thereto. In some embodiments of the present invention, a melting point of PE in the cover panel material may be from 100° C. to 135° C., but it is not limited thereto. In some embodiments of the present invention, the foresaid PE in the cover panel material may be low density polyethylene (LDPE).

In some embodiments of the present invention, a density of NR in the cover panel material may be from 0.91 g/cm³ to 0.93 g/cm³, but it is not limited thereto. In some embodiments of the present invention, a Mooney viscosity ML(1+4) at 100° C. of NR may be from 50 MU (Mooney unit) to 90 MU, but it is not limited thereto, and the foresaid description of “ML(1+4) at 100° C.”indicates that the result is measured by a Mooney viscometer using large rotor at 100° C. for 4 minutes after 1 minute preheating time.

In some embodiments of the present invention, the filler in the cover panel material comprises calcium carbonate (CaCO₃).

In some embodiments of the present invention, the crosslinking agent in the cover panel material comprises dicumyl peroxide (DCP).

In some embodiments of the present invention, the foaming agent in the cover panel material comprises azodicarbonamide or 4,4′-oxybis(benzenesulfonylhydrazide) (OBSH).

In some embodiments of the present invention, the anti-wear agent in the cover panel material comprises rosin. In some embodiments of the present invention, a melting point of the foresaid rosin may be from 75° C. to 95° C., but it is not limited thereto.

In some embodiments of the present invention, a density of each cover panel is independently from 0.15 g/cm³ to 0.17 g/cm³.

In some embodiments of the present invention, a thickness of each cover panel is independently from 0.8 mm (millimeter) to 2 mm.

In some embodiments of the present invention, the surface of the basketball carcass comprises at least two convex strips formed between any two adjacent said cover panels.

In some embodiments of the present invention, the basketball carcass comprises: a bladder; a yarn wrapped layer, wrapped around a surface of the bladder; and a middle layer, formed on a surface of the yarn wrapped layer and completely covering the surface of the yarn wrapped layer; wherein a surface of the middle layer is the surface of the basketball carcass.

Besides, the present invention further provides a manufacturing method of the foresaid basketball with EVA cover panels, which comprises the following steps: step (a): providing a basketball carcass; step (b): providing a cover panel material, wherein the cover panel material comprises EVA, a foaming agent, a filler, PE, NR, a crosslinking agent, ZnO, stearic acid and an anti-wear agent; step (c): foaming the cover panel material to obtain an unsliced cover panel; and step (d): slicing the unsliced cover panel into pieces of cover panels, and fixing at least two of the pieces of cover panels onto a surface of the basketball carcass, and the basketball with EVA cover panels is obtained.

In some embodiments of the present invention, in the step (c), the cover panel material is foamed under a pressure of 9 MPa to 11 MPa at 160° C. to 180° C. for 8 minutes to 10 minutes.

In this specification, a range represented by “a lower-endpoint value to an upper-endpoint value”, unless otherwise specified, indicates that the range is more than or equal to the lower-endpoint value and less than or equal to the upper-endpoint value. For example, “from 8 parts by weight to 15 parts by weight” indicates that a range of “more than or equal to 8 parts by weight and less than or equal to 15 parts by weight”.

Other objectives, advantages and novel features of the instant disclosure will become more apparent from the following detailed description when taken in conjunction with the accompanying drawings.

### BRIEF DESCRIPTION OF THE DRAWINGS

FIG. 1 is a schematic diagram to demonstrate the relationship among different structures of some embodiments of the basketball with EVA cover panels of the present invention.

FIG. 2 is a sectional view of the embodiments of the basketball with EVA cover panels of the present invention shown in FIG. 1.

### DETAILED DESCRIPTION OF THE PREFERRED EMBODIMENTS

Hereinafter, some embodiments are exemplified to illustrate the implementation and effects of the present invention. One person skilled in the art can easily realize the advantages and effects of the present invention in accordance with the contents of the specification. Various modifications and variations could be made in order to practice or apply the present invention without departing from the scope of the invention.

### Example 1: Basketball With EVA Cover Panels

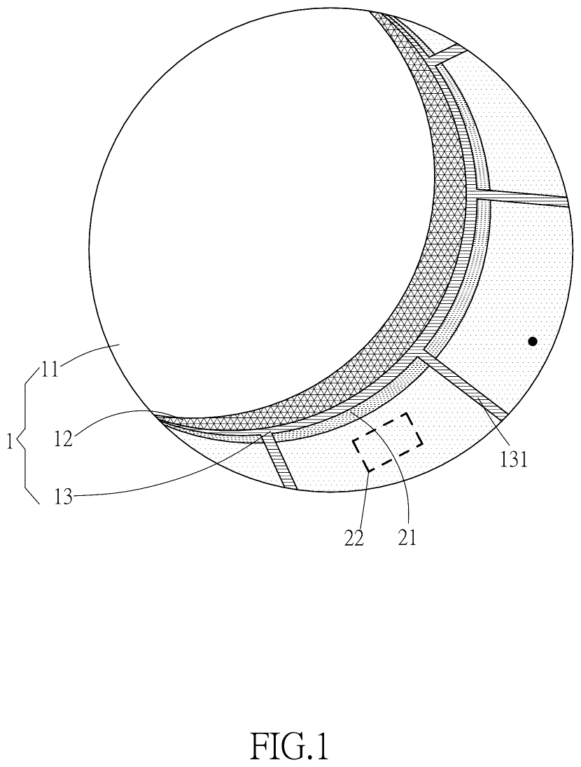

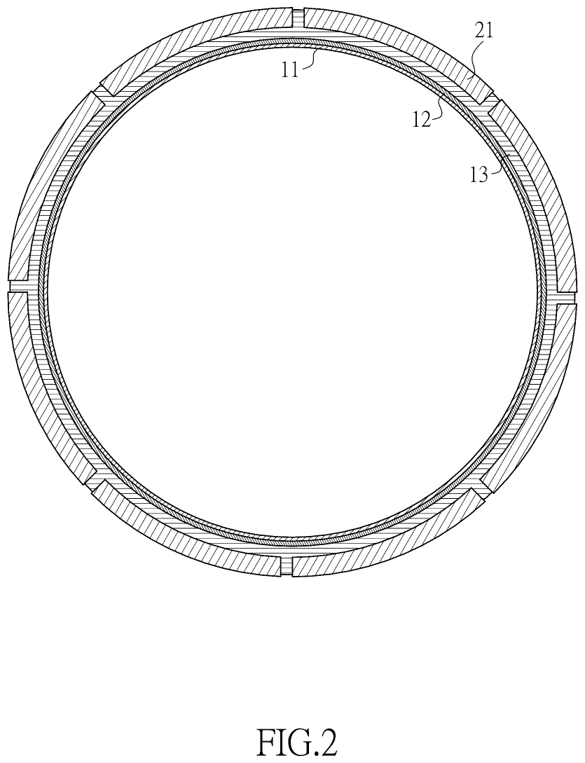

Please refer to FIG. 1 and FIG. 2, which demonstrate some embodiments of the basketball with EVA cover panels of the present invention, and FIG. 1 is used to explain the relationship among different structures of the basketball with EVA cover panels and FIG. 2 is a sectional view of the same.

Specifically, the basketball with EVA cover panels comprised a basketball carcass 1 and eight cover panels 21, disposed on a surface of the basketball carcass 1. The basketball carcass 1 comprised a bladder 11; a yarn wrapped layer 12, which was wrapped around a surface of the bladder 11; and a middle layer 13, formed on a surface of the yarn wrapped layer 12 and completely covered the surface of the yarn wrapped layer 12; wherein a surface of the middle layer 13 equaled the surface of the basketball carcass 1. The surface of the basketball carcass 1, i.e., the surface of the middle layer 13, had eight concave areas used for accommodating the eight cover panels 21, and eight convex strips 131 were formed between any two adjacent said cover panels 21. A vertical distance from a surface of each convex strip 131 to the surface of the basketball carcass 1 was less than a vertical distance from a surface of each cover panel 21 to the surface of the basketball carcass 1. Also, a trademark 22 was formed on the surface of one cover panel 21.

For manufacturing the basketball with EVA cover panels of Example 1, a basketball carcass 1 was provided by known technical means and materials.

Next, a cover panel material was obtained by mixing the following components:
1. 25 kilograms (kg) of EVA, purchased from Braskem America, Inc.; item name: SVT2180;
2. 17 kg of PE, purchased from Braskem America, Inc.; item name: SBE853;
3. 7 kg of NR, purchased from VIET PHU THINH RUBBER JOINT STOCK COMPANY (VIRUCO);
4. 25 kg of CaCO₃;
5. 0.7 kg of DCP (as a crosslinking agent);
6. 3 kg of azodicarbonamide (as a foaming agent), purchased from DongGuan Haili Chemical Materials Co., Ltd.; item name: AC3000;
7. 0.8 kg of ZnO;
8. 0.8 kg of stearic acid; and
9. 1 kg of rosin (as an anti-wear agent), purchased from JAYI INDUSTRY CO., LIMITED; item name: FS-508.

In other words, based on a weight of EVA as 100 parts by weight, a content of PE was about 68 parts by weight, a content of NR was about 28 parts by weight, a content of CaCO₃ was about 100 parts by weight, a content of DCP was about 2.8 parts by weight, a content of azodicarbonamide was about 12 parts by weight, a content of ZnO was about 3.2 parts by weight, a content of stearic acid was about 3.2 parts by weight and a content of rosin was about 4 parts by weight.

Next, the cover panel material was foamed under a pressure of about 10 MPa at 160° C. to 180° C. for 8 minutes to 10 minutes to obtain an unsliced cover panel.

Next, the unsliced cover panel was sliced into eight pieces of cover panels 21, and the eight pieces of cover panels 21 were fixed onto the surface of the basketball carcass 1 with a glue, and thus the eight pieces of cover panels 21 were accommodated in the foresaid eight concave areas, and then the basketball with EVA cover panels of Example 1 was obtained.

In summary, as the present invention adopts the specific composition of the cover panel material, the basketball with EVA cover panels of the present invention can have good elasticity, good touch and non-slip at the same time, thereby providing a basketball with special materials of cover panels that benefits the participants of the basketball sport.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A basketball with ethylene vinyl acetate cover panels, comprising:
a basketball carcass, and at least two cover panels disposed on a surface of the basketball carcass;
wherein the at least two cover panels are made by foaming a cover panel material, and the cover panel material comprises ethylene vinyl acetate, a foaming agent, a filler, polyethylene, natural rubber, a crosslinking agent, zinc oxide, stearic acid and an anti-wear agent.

2. The basketball with ethylene vinyl acetate cover panels as claimed in claim 1, wherein in the cover panel material, based on a weight of ethylene vinyl acetate as 100 parts by weight, a content of the foaming agent is from 8 parts by weight to 15 parts by weight, a content of the filler is from 60 parts by weight to 110 parts by weight, a content of polyethylene is from 60 parts by weight to 80 parts by weight, a content of the natural rubber is from 20 parts by weight to 40 parts by weight, a content of the crosslinking agent is from 2 parts by weight to 4 parts by weight, a content of zinc oxide is from 1 part by weight to 5 parts by weight, a content of stearic acid is from 1 part by weight to 5 parts by weight and a content of the anti-wear agent is from 2 parts by weight to 6 parts by weight.

3. The basketball with ethylene vinyl acetate cover panels as claimed in claim 1, wherein the filler in the cover panel material comprises calcium carbonate.

4. The basketball with ethylene vinyl acetate cover panels as claimed in claim 1, wherein the crosslinking agent in the cover panel material comprises dicumyl peroxide.

5. The basketball with ethylene vinyl acetate cover panels as claimed in claim 1, wherein the foaming agent in the cover panel material comprises azodicarbonamide or 4,4′-oxybis(benzenesulfonylhydrazide).

6. The basketball with ethylene vinyl acetate cover panels as claimed in claim 1, wherein the anti-wear agent in the cover panel material comprises rosin.

7. The basketball with ethylene vinyl acetate cover panels as claimed in claim 1, wherein a density of each cover panel is independently from 0.15 g/cm³ to 0.17 g/cm³.

8. The basketball with ethylene vinyl acetate cover panels as claimed in claim 1, wherein a thickness of each cover panel is independently from 0.8 mm to 2 mm.

9. The basketball with ethylene vinyl acetate cover panels as claimed in claim 1, wherein the surface of the basketball carcass comprises at least two convex strips formed between any two adjacent said cover panels.

10. The basketball with ethylene vinyl acetate cover panels as claimed in claim 1, wherein the basketball carcass comprises:
a bladder;
a yarn wrapped layer, wrapped around a surface of the bladder; and
a middle layer, formed on a surface of the yarn wrapped layer and completely covering the surface of the yarn wrapped layer;
wherein a surface of the middle layer is the surface of the basketball carcass.

11. A manufacturing method of the basketball with ethylene vinyl acetate cover panels as claimed in claim 1, comprising steps as follows:
step (a): providing a basketball carcass;
step (b): providing a cover panel material, wherein the cover panel material comprises ethylene vinyl acetate, a foaming agent, a filler, polyethylene, natural rubber, a crosslinking agent, zinc oxide, stearic acid and an anti-wear agent;
step (c): foaming the cover panel material to obtain an unsliced cover panel; and
step (d): slicing the unsliced cover panel into pieces of cover panels, and fixing at least two of the pieces of cover panels onto a surface of the basketball carcass, thereby obtaining the basketball with ethylene vinyl acetate cover panels.

12. The manufacturing method as claimed in claim 11, wherein in the step (c), the cover panel material is foamed under a pressure of 9 MPa to 11 MPa at 160° C. to 180° C. for 8 minutes to 10 minutes.
